(19) United States
(12) Patent Application Publication
(10) Pub. No.: US 2002/0004901 A1
(43) Pub. Date: Jan. 10, 2002

(54) Systems and methods for PKI-enabling applications using application-specific certificates

(76) Inventors: See-Wai Yip, Singapore (SG); Kok-Khuan Fong, The Rivervale (SG); Kok-Hoon Teo, Singapore (SG); Eng-Whatt Toh, Singapore (SG)

Correspondence Address: MADSON & METCALF, GATEWAY TOWER WEST, SUITE 900, 15 WEST SOUTH TEMPLE, SALT LAKE CITY, UT, 84101

(21) Appl. No.: 09/775,172

(22) Filed: Feb. 1, 2001

Related U.S. Application Data
(60) Provisional application No. 60/217,010, filed on Jul. 10, 2000.
(60) Provisional application No. 60/246,451, filed on Nov. 7, 2000.

(51) Int. Cl. H04L 9/00; G06F 17/60

(52) U.S. Cl. 713/156; 705/76; 713/200

(57) ABSTRACT

Applications are integrated with application-specific certification authorities (CAs) for issuing application-specific certificates. For each certificate issued to a subscriber by a master CA, the application-specific CAs issue corresponding application-specific certificates to the subscriber. For each certificate revoked master CA, the application-specific CAs revoke the corresponding application-specific certificates of the subscriber.

### RELATED APPLICATIONS

This application is related to, and claims priority from, U.S. Provisional Application No. 60/217,010, filed Jul. 10, 2000, for “A Companion Certificate System for PKI-Enabling Applications.” This application is also related to, and claims priority from, U.S. Provisional Application No. 60/246,451, filed Nov. 7, 2000, for “A Companion Certificate System for PKI-Enabling Applications.” Both of these applications are commonly assigned and are hereby incorporated by reference.

### BACKGROUND

1. Field of the Invention

The present invention relates generally to public key infrastructures (PKIs) and, more particularly, to systems and methods for PKI-enabling applications using application-specific certificates.

2. Description of the Background Art

One of the primary barriers to the development of electronic commerce is establishing trust between parties to an electronic transaction. Each party needs to be confident that the other party or parties are who they claim to be. A public key infrastructure (PKI) is a system of trusted third parties (TTPs) who attest to the identity of each individual involved in an electronic transaction.

Based on the science of asymmetric key cryptography, a PKI uses two different but mathematically-related keys. The keys have the properties that (1) one key can be used to encrypt a message that can only be decrypted using the other key, and (2) even knowing one key, it is computationally infeasible to discover the other key. One of the keys is made public and published to the world (i.e. a “public” key), while the other key is kept private and stored in a secure location (i.e. a “private” key).

A certification authority (CA) is a component of a PKI that is responsible for issuing certificates to “subscribers” (e.g., certificate holders). A certificate is a record that contains the public key of the subscriber as well as other identifying information. The certificate is digitally signed using the private key of the CA. Thus, any party receiving the certificate can determine whether the certificate is authentic and unmodified by decrypting the certificate using the CA's public key, which is readily available through print publicity or the like. The CA is also responsible for revoking certificates that, for whatever reason, are no longer valid.

A registration authority (RA) is a component of a PKI that is responsible for verifying that subscribers are who they claim to be before a certificate is issued by the CA. The RA ensures that the subscriber has provided the proper identification credentials required by the certificate's “policy” and that the information provided by the subscriber is accurate. The RA typically takes the form of a tool used by a human administrator to perform the required verification steps and to input identifying information. However, it is also possible for the RA function to be completely automated. Often, the RA component of a PKI is integrated with the CA component.

A directory service is a component of a PKI that allows the certificates to be retrieved upon demand. The certificates are typically stored in a certificate repository, which is a database of certificates. The directory service also stores a certificate revocation list (CRL), which is a list of the certificates that have been revoked. Like the RA component, the directory service is often integrated with the CA component of the PKI.

Once a certificate is issued, it may be used for a variety of purposes, such as authenticating a user for an application (e.g., a client or server program), encryption, verification, digitally signing data, and the like.

Unfortunately, there is no single PKI standard or universal certificate. Indeed, there are nearly as many different certificates as there are companies providing certification authority services. The lack of a clear PKI standard results in interoperability problems that prior systems have been unable to solve. While attempts have been made to achieve “cross-certification” of certificates from different PKI domains, a number of different (and incompatible) techniques have developed. Such techniques are highly complicated and pose security risks.

Application developers are particularly sensitive to these difficulties. Conventionally, in order to “PKI-enable” an application (i.e. provide PKI services for authentication, encryption, verification, digital signatures, etc.), the developer must provide support in the application for a number of different certificates. This increases the complexity of the application, as well as the application's cost and the likelihood of programming errors.

In addition, by relying upon the infrastructure of various certification authorities, developers lose control over the quality of service provided by their applications. Since each application must access the directory service of the CA that issued the certificate, an overload or failure of a CA could potentially slow down or cripple the application.

Accordingly, what is needed is a technique for PKI-enabling an application that does not require supporting numerous different certificates. Additionally, what is needed is a technique for PKI-enabling an application that is not dependent on the directory services or other infrastructure of an external CA.

### SUMMARY OF THE INVENTION

The present invention relates to systems and methods for PKI-enabling a plurality of applications using application-specific certificates. In one aspect of the invention, an application is integrated with a first certification authority (CA) for issuing application-specific certificates. Whenever a notice is received of a second CA issuing a certificate to a subscriber, the first CA issues a corresponding application-specific certificate to the subscriber for use with the application. The notice may be sent by a registration authority (RA) associated with the second CA after registering the subscriber or the first CA may be set to monitor the second CA's registration.

In one embodiment, the application is also integrated with an application-specific certificate repository for storing the application-specific certificate and an application-specific directory service for providing access to the stored certificate. Likewise, the application may be integrated with an application-specific RA for registering a subscriber for the application, independent of whether the subscriber was registered by the RA associated with the second CA.

In another aspect of the invention, a combined RA is provided for registering subscribers for a plurality of applications. Upon registering a subscriber, the combined registration authority notifies the application-specific RA associated with each application. Thereafter, the application-specific CA of each application issues an application-specific certificate to the subscriber for use with the application.

In yet another aspect of the invention, a master CA issues a master certificate to a subscriber in response to the subscriber being registered by a master RA. The master certificate is stored within or made accessible to an authentication module for use by the subscriber. The master RA notifies a plurality of applications of the registration. The applications, in turn, issue corresponding application-specific certificates to the subscriber. The private keys associated with the application-specific certificates are encrypted by an encryption module using the public key associated with the master certificate and are stored within or made accessible to the authentication module.

After a user signs on, the authentication module authenticates the subscriber with a master authentication service CA using the master certificate. If the subscriber is successfully authenticated, a decryption module decrypts the private keys associated with the application-specific certificates. Thereafter, the authentication module authenticates the subscriber for each application using the corresponding decrypted private keys associated with each application-specific certificate.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is a schematic block diagram of a conventional system for providing PKI services to a plurality of applications;

FIG. 2 is a schematic block diagram of a system for PKI-enabling an application;

FIG. 3 is a schematic block diagram of a system for PKI-enabling a plurality of applications;

FIG. 4 is a flowchart of a method for PKI-enabling an application;

FIGS. 5 and 6 are schematic block diagrams of a system for PKI-enabling a plurality of applications.

The Figures depict embodiments of the present invention for purposes of illustration only. Those skilled in the art will recognize from the following discussion that alternative embodiments of the illustrated structures and methods may be employed without departing from the principles of the invention described herein.

### DETAILED DESCRIPTION OF THE PREFERRED EMBODIMENTS

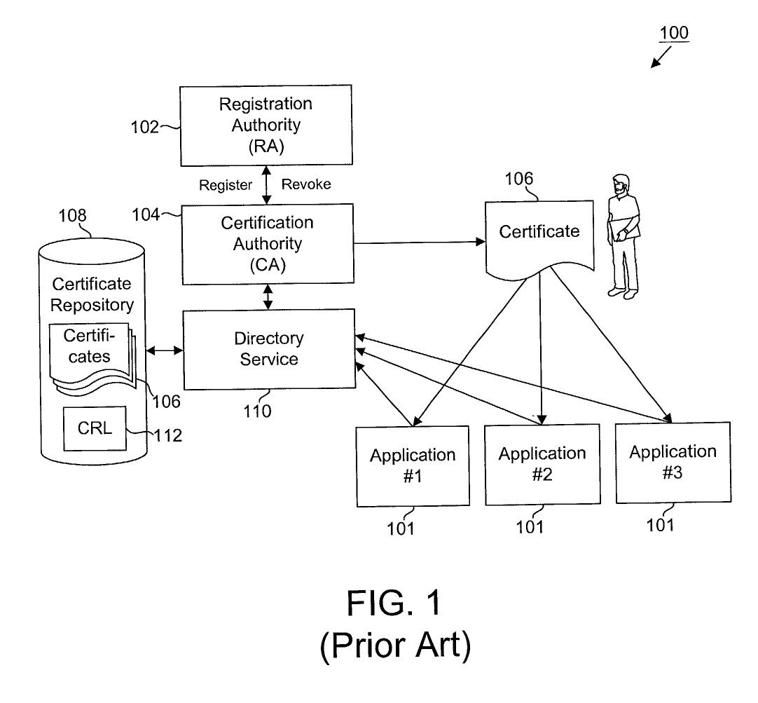

FIG. 1 illustrates a conventional system 100 for providing PKI services to a plurality of applications 101. Initially, a registration authority (RA) 102 obtains and verifies a subscriber's identification credentials. For example, a human operator may visually inspect a subscriber's driver's license, passport, birth certificate, etc., and input corresponding numbers or identifiers into the RA 102. Where more security is required, the RA 102 may obtain and verify biometric data, such as fingerprint or retinal images. The types of identification credentials and the degree of verification required by the RA 102 are typically dictated by a “policy” associated with the particular certificate sought by the subscriber.

After the subscriber's identity is verified, the RA 102 typically instructs a certification authority (CA) 104 to issue a certificate 106 to the subscriber. A certificate 106 is a record including the public key of the subscriber and other identifying information. The certificate 106 is digitally signed using the private key of the CA 104. Thus, any party receiving the certificate 106 can easily determine whether the certificate 106 is authentic and unmodified by decrypting the certificate 106 using the CA's public key, which is readily available through print publicity or the like.

Typically, the certificate 106 is stored in a certificate repository 108, which is used by a directory service 110 to provide access to the stored certificates 106. Various directory services 110 are known, such as a directory service 110 implementing the lightweight directory access protocol (LDAP) or X.500.

As illustrated in FIG. 1, the RA 102 may also instruct the CA 104 to revoke the subscriber's certificate 106 if, for whatever reason, the certificate 106 is no longer valid. An indication of the revoked certificate 106 is typically stored in a certificate revocation list (CRL) 112 within the certificate repository 108.

Often, the RA 102, the CA 104, the certificate repository 108, and the directory service 110 are collectively referred to as a “certification authority” or “CA,” since each are concerned with the issuance and management of certificates 106. Moreover, the RA 102, the certificate repository 108, and the directory service 110 are sometimes integrated with the CA 104 in certain implementations. Thus, as used herein, the terms “certification authority” and “CA” are not restricted to the component of a PKI that issues certificates 106, but may also include one or more of the RA 102, the certificate repository 108, and the directory service 110.

After a certificate 106 is issued, a subscriber may use the certificate 106 with a plurality of applications 101 for various purposes, such as authentication, encryption, verification, digital signatures, and the like. For example, as shown in FIG. 1, a subscriber may use his or her certificate 106 to authenticate with a number of applications 101.

Typically, when a certificate 106 is presented by a subscriber, each application 101 accesses the directory service 110 associated with the CA 104 that issued the certificate 106 in order to determine whether the certificate 106 is still valid (e.g., not in the CRL 112). If the certificate 106 is still valid and the subscriber holds the corresponding private key, the subscriber is allowed to use the application 101.

Conventionally, each application 101 must be configured to (1) recognize the subscriber's certificate 106 and (2) access the directory service 110 of the issuing CA 104. Unfortunately, there is no single PKI standard or universal certificate 106. Indeed, there are nearly as many different certificates 106 are there are companies providing certification authority services. In some cases, the directory service 110 may not be generally available for application access, especially if the directory service belongs to an enterprise and the application 101 is an inter-enterprise application.

The lack of uniform PKI implementation and the difficulty in sharing directory services 110 result in interoperability problems that have not been solved by prior approaches. While attempts have been made to achieve “cross-certification” of certificates 106 from different PKI domains, a number of different (and incompatible) techniques have developed. Such techniques are highly complicated and pose security risks.

Application developers are particularly sensitive to these difficulties. Conventionally, in order to “PKI-enable” an application 101 (i.e. provide PKI services for use in authentication, encryption, verification, digital signatures, etc.), the developer must provide support in the application 101 for a number of different certificates 106. This increases the complexity of the application 101, as well as the application's cost and the likelihood of programming errors.

In addition, by relying upon the infrastructure of various CAs 104, developers lose control over the quality of service provided by their applications 101. Since each application 101 must access the directory service 110 of the CA 104 that issued the certificate 106, an overload or failure of a CA 104 could potentially slow down or cripple the application 101.

Accordingly, the present invention provides systems and methods for PKI-enabling an application 101 that do not need to support numerous different certificates 106. Additionally, the present invention provides systems and methods for PKI-enabling an application 101 that are not dependent on the directory services 110 or other infrastructure of an external CA 104, allowing the application 101 to provide quality of service guarantees.

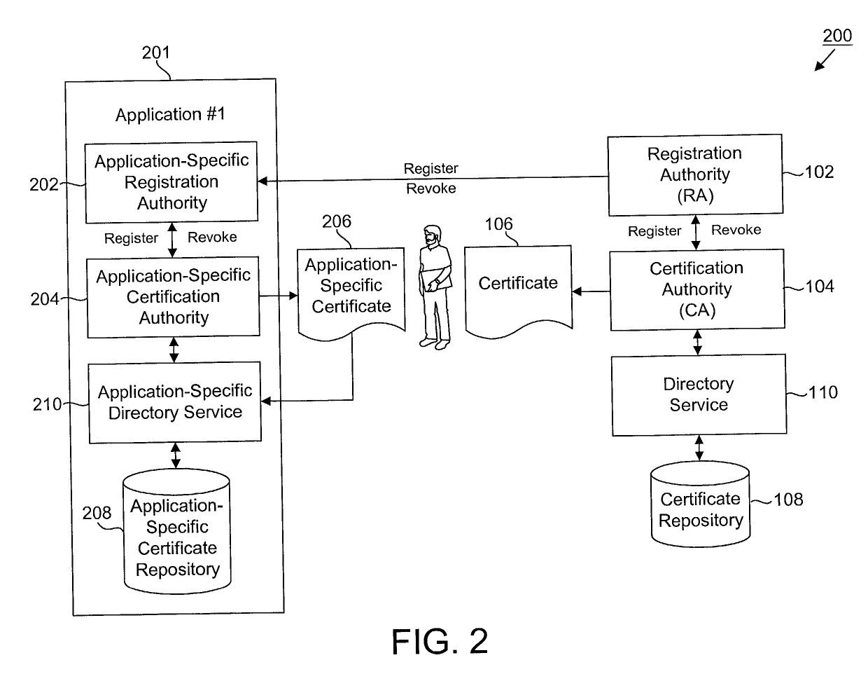

Referring now to FIG. 2, there is shown a system 200 for PKI-enabling an application 201 according to an embodiment of the invention. In the depicted embodiment, a conventional RA 102 registers subscribers and a conventional CA 104 issues certificates 106 to the registered subscribers, as described in connection with FIG. 1. The RA 102 and CA 104 may be provided by any enterprise for its employees, or any company or entity offering certification authority services, such as Entrust® or Verisign®. As used herein, the RA 102 is referred to as a “master RA” and the CA 104 is sometimes referred to as a “master CA.” Unlike the system 100 of FIG. 1, however, each application 201 of the system 200 is integrated with an application-specific RA 202 and an application-specific CA 204. In one embodiment, the application-specific RA 202 registers subscribers for the application 201, while the application-specific CA 204 issues application-specific certificates 206. In one implementation, the application-specific RA 202 and CA 204 run on the same physical host as the application 201. In alternative embodiments, however, the application-specific RA 202 and CA 204 execute on one or more different physical hosts and communicate with the application 201 via a network (not shown). Thus, the application 201, the application-specific RA 202, and the application-specific CA 204 need not be hosted on the same machine or provided by the same entity.

An application-specific certificate 206 differs from a conventional certificate 106 in that it is configured for use with a single application 201. As such, an application-specific certificate 206 may have any desired format, greatly reducing the complexity of application development since the application 201 need not support multiple certificate types. For example, each application-specific certificate 206 may conform to the X.509 standard, regardless of the format of the certificate 106. In one implementation, the certificate 106 and the application-specific certificate 206 are associated with different public/private key pairs.

As shown in FIG. 2, an application 201 is also integrated with an application-specific certification repository 208 for storing application-specific certificates 206 and an application-specific directory service 210 for providing access to the certificates 206 on demand. Thus, unlike the system 100 of FIG. 1, an application 201 need not rely upon the infrastructure of an external CA 104 in order to use PKI services, making it possible to provide quality of service guarantees for the application 201.

In one implementation, whenever the conventional CA 104 issues a certificate 106 to a subscriber, the application-specific CA 204 issues to the subscriber a corresponding application-specific certificate 206. The RA 102 may send, for example, a notice to the application-specific RA 202 whenever a subscriber is registered. The format of the notice is not crucial to the invention. For instance, the RA 102 may use standard protocols, such as X.509.

In an alternative embodiment, the CA 104 directly communicates with the application-specific CA 204 whenever a certificate 106 is issued. In yet another embodiment, the application-specific CA 204 periodically queries the RA 102 and/or CA 104 to determine whether any subscribers were registered or certificates 106 were issued.

Likewise, if the subscriber's certificate 106 is later revoked, the application-specific CA 204 preferably revokes the corresponding application-specific certificate 206. This may be done, for example, by storing an indication of the revoked certificate 206 a certification revocation list 112 within the application-specific certificate repository 208 or another suitable location.

In one implementation, the RA 102 or CA 104 sends a notice to the application-specific RA 202 whenever a certificate 106 is revoked. Alternatively, the application-specific RA 202 or CA 204 periodically queries the RA 102 or CA 104 for a list of revoked certificates 106.

Thus, for every certificate 106 issued by the CA 104, a “companion,” application-specific certificate 106 is issued by the application-specific CA 204 for use with the particular application 201. Advantageously, the format of the application-specific certificate 206 is not dependent on the format of the certificate 106. Moreover, because the application 201 is not dependent upon the directory service 110 or other infrastructure of the CA 104, the quality of service of the application 201 may be guaranteed. Additionally, the system 200 results in better load balancing since each application 201 is responsible for its own PKI infrastructure.

Of course, the application-specific RA 202 may be used to register a subscriber for an application-specific certificate 206 independent of whether the corresponding RA 102 has registered the subscriber or the corresponding CA 104 has issued a certificate 106.

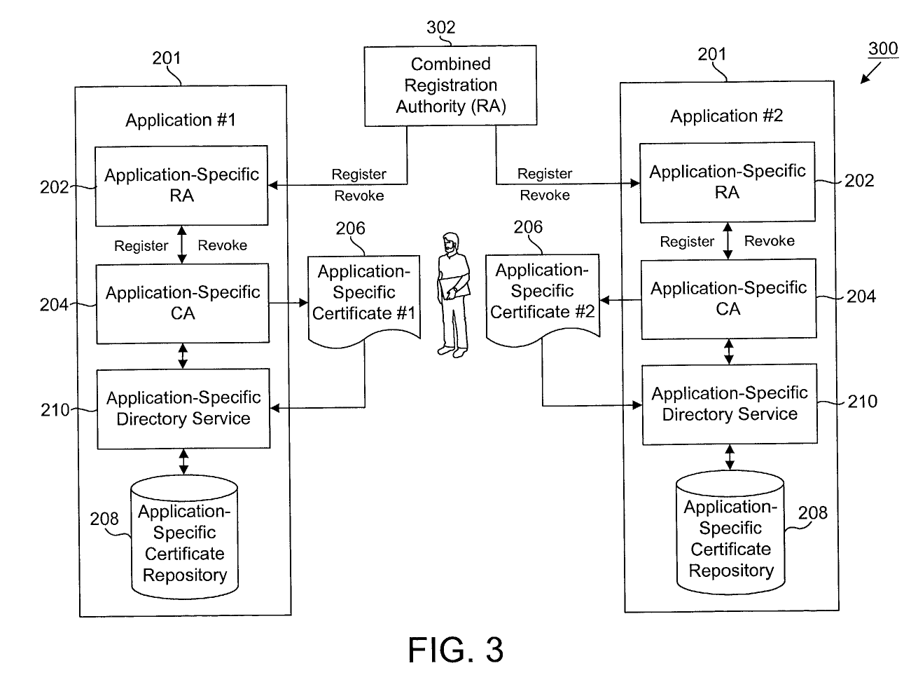

Referring now to FIG. 3, there is shown a system 300 for PKI-enabling a plurality of applications 201 according to an embodiment of the invention. As depicted, each application 201 is integrated with an application-specific RA 202, CA 204, certificate repository 208, and directory service 210, all of which function as described above with reference to FIG. 2.

In addition, a combined registration authority (RA) 302 is provided in one embodiment. The combined RA 302 registers subscribers in the same manner that the RA 102 registers subscribers. However, in one implementation, the combined RA 302 notifies the application-specific RA 202 of each application 201 whenever a subscriber is registered. The notification may use any conventional protocol, such as PKIX.

In an alternative embodiment, the combined RA 302 directly notifies the application-specific CA 204 of each application 201 whenever a subscriber is registered. In yet another alternative embodiment, the application-specific RA 202 or CA 204 periodically queries the combined RA 302 to determine whether any subscribers have been registered.

In one implementation, whenever a subscriber is registered by the combined RA 302, the application-specific CA 204 of each application 201 issues a corresponding application-specific certificate 206. For example, as shown in FIG. 3, after registration of a subscriber by the combined RA 302, the application-specific CA 204 of application #1 issues a first application-specific certificate 206 and the application-specific CA 204 of application #2 issues a second application-specific certificate 206.

The first and second application-specific certificates 206 need not have the same format or be associated with the same PKI key pair. Each application-specific certificate 206 need only be configured for use with the corresponding application 201, simplifying application design and operation.

Additionally, whenever a subscriber is revoked by the combined RA 302, the application-specific CA 204 of each application 201 preferably revokes the corresponding application-specific certificate 206 of the subscriber. This may be accomplished, for example, by storing an indication of the revoked certificate 206 in a certification revocation list 112 within the application-specific certificate repository 208 or another suitable location.

As before, the combined RA 302 may also send a notice to the application-specific RA 202 or CA 204 of each application 201 whenever a subscriber is revoked. Alternatively, each application-specific RA 202 or CA 204 may periodically query the combined RA 102 for an updated list of revoked subscribers.

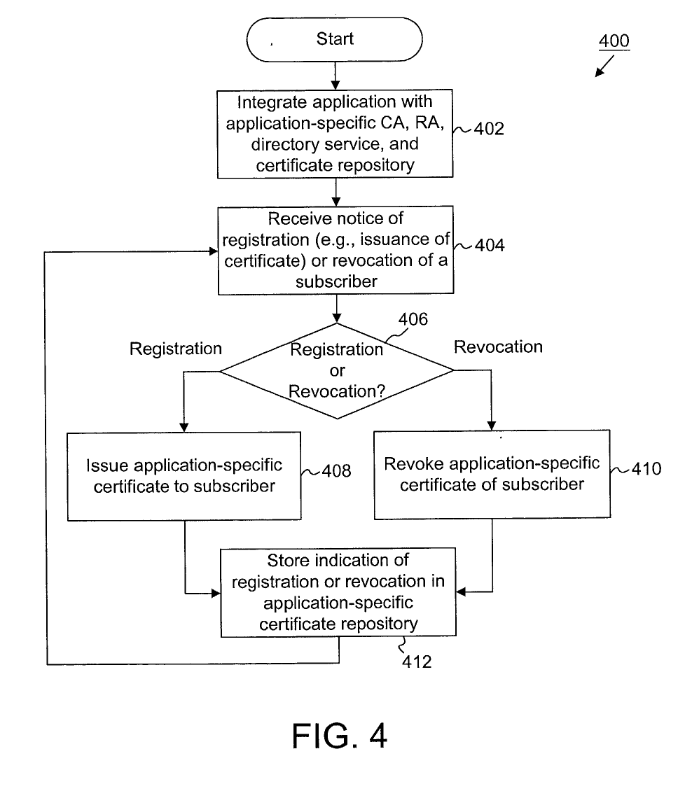

FIG. 4 is a flowchart of a method 400 for PKI-enabling an application 201 that summarizes the above-described process. The method 400 includes, in one embodiment, a preparation phase and an operational phase. In the preparation phase, the application 201 is integrated 402 with an application-specific RA 202, CA 204, certificate repository 208, and directory service 210. These application-specific components may be installed on the same physical machine as the application 201 or may be installed on a different machine and linked to the application 201 via a network connection.

In the operational phase, a notice of a subscriber's registration or revocation is received 404. The notice may or may not be received in response to a query. A determination 406 is then made as to whether the notice relates to a registration or a revocation. In the case of a registration, an application-specific certificate 206 is issued 408 to the subscriber. In the case of a revocation, the application-specific certificate 206 of the subscriber is revoked 410 (assuming that an application-specific certificate 206 was previously issued).

After either of steps 408 or 410, the method 400 continues by storing 412 an indication of the registration or revocation in the application-specific certificate repository 208 or another suitable location. The indication may include an actual certificate 206, an entry in a certificate revocation list (CRL) 112, or another type of indication. In one embodiment, the method returns to step 404 to receive the next notice of a registration or revocation.

In the system 300 of FIG. 3 described above, a subscriber would typically need to separately authenticate with each application 201 using a corresponding application-specific certificate 206. This may require the subscriber to enter multiple passwords, insert multiple security devices, etc. However, it would be advantageous to allow a subscriber to authenticate only a single time and thereafter be automatically authenticated for each of a plurality of applications 201.

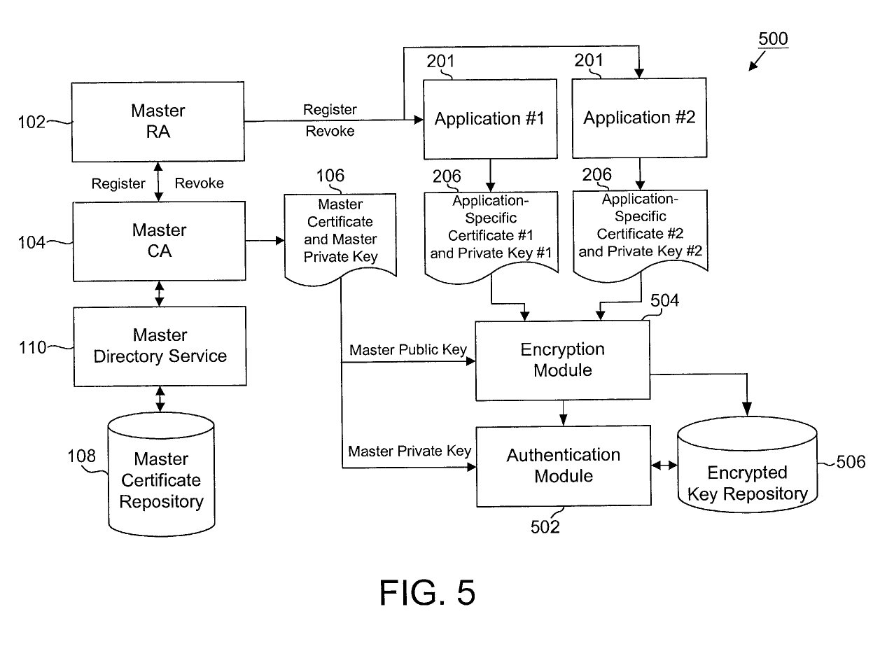

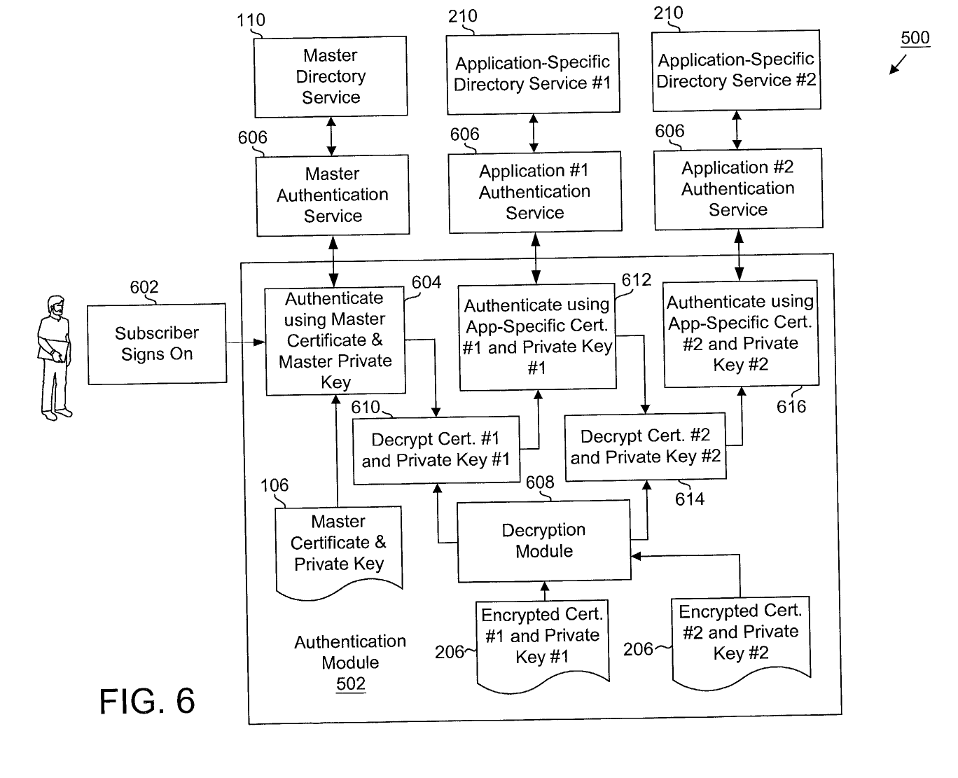

Accordingly, FIGS. 5 and 6 illustrate a system 500 for PKI-enabling a plurality of applications 201 in which a subscriber need only authenticate a single time in order to be automatically authenticated for each application 201. In one embodiment, a master RA 102 registers a subscriber and a master CA 104 issues a master certificate 106 to the registered subscriber. In addition, the master RA 102 notifies each application 201 of the registration, after which corresponding application-specific certificates 206 are issued to the subscriber, as described in connection with FIG. 3.

In the depicted embodiment, the master certificate 106 is stored within or made accessible to (e.g., online) an authentication module 502. As described below in connection with FIG. 6, the authentication module 502 is configured to authenticate the subscriber for one or more applications 201 using standard PKI authentication techniques.

In one implementation, an encryption module 504 encrypts the private keys associated with the application-specific certificates 206 using the public key associated with the master certificate 106. The encrypted private keys may be stored in an encrypted key repository 506 or other suitable location. In various embodiments, the encryption module 504 and the encrypted key repository 506 may be integrated (or in communication) with the authentication module 502.

As depicted, the encryption module 504 may also encrypt the application-specific certificates 206 and store the same with the encrypted private keys. However, this is not a requirement in every embodiment of the invention.

As illustrated in FIG. 6, a subscriber initially signs on 602 to the authentication module 502. For example, the subscriber may enter a pass phrase, insert a security device, or the like. Thereafter, the authentication module 502 uses the master certificate 106 and the master private key to authenticate 604 the subscriber with a master authentication service 606.

The master authentication service 606 is preferably in communication with the master directory service 110. Various public key authentication techniques may be used which are well known to those skilled in the art.

If the subscriber is successfully authenticated, a decryption module 608 decrypts 610 the application-specific certificate 206 and corresponding private key using the private key associated with the master certificate 106. The decryption module 608 may be integrated with the authentication module 502 or may be implemented as a separate module in communication with the authentication module 502.

The decrypted application-specific certificate 206 and corresponding private key are then used to authenticate 612 the subscriber with an authentication service 606 of the first application 201. In the same manner, the decryption module 608 decrypts 614 the application-specific certificate 206 and corresponding private key of the second application 201, which are then used to authenticate 616 the subscriber with an authentication service 606 of the second application 201.

If the user does not authenticate successfully with the master authentication service 606, the decryption module 608 does not decrypt the encrypted application-specific certificates 206 and private keys. Thus, if the master certificate 106 of the subscriber is revoked or invalid, the application-specific certificates 206 and private keys are unusable since they cannot be decrypted. As a consequence, each application-specific certificate 206 inherits the trust of the master certificate 106.

In view of the foregoing, the present invention offers numerous advantages not available in conventional approaches. Applications are PKI-enabled without requiring developers to support numerous different certificates. Additionally, applications are PKI-enabled without making them dependent on the directory services or other infrastructure of an external or enterprise certification authority. Moreover, in one implementation, subscribers may authenticate a single time, after which they are automatically authenticated for a plurality of applications. The application-specific certificates may also be encrypted using the public key associated a master certificate and only decrypted if the subscriber successfully authenticates with a master authentication service. Thus, if a master certificate is revoked or found to be invalid, the application-specific certificates are rendered unusable.

As will be understood by those familiar with the art, the invention may be embodied in other specific forms without departing from the spirit or essential characteristics thereof. Likewise, the particular naming of the modules, features, attributes or any other aspect is not mandatory or significant, and the mechanisms that implement the invention or its features may have different names or formats. Accordingly, the disclosure of the present invention is intended to be illustrative, but not limiting, of the scope of the invention, which is set forth in the following claims.

We claim:

1. A method in a computer system for PKI-enabling an application, the method comprising:
integrating the application with an application-specific certification authority for issuing application-specific certificates;
receiving notice of a master certification authority issuing a master certificate to a subscriber; and
issuing to the subscriber an application-specific certificate corresponding to the master certificate, the application-specific certificate for use by the application.

2. The method of claim 1, further comprising:
integrating the application with a directory service for providing access to application-specific certificates for the application.

3. The method of claim 2, wherein the directory service comprises one of a lightweight directory access protocol (LDAP) service, an X.500 directory, and a database.

4. The method of claim 2, wherein the directory service comprises a certificate repository, and wherein issuing comprises:
storing the application-specific certificate in the certificate repository of the directory service.

5. The method of claim 1, further comprising:
receiving notice of the master certification authority revoking the master certificate of the subscriber; and
revoking the application-specific certificate of the subscriber corresponding to the revoked master certificate.

6. The method of claim 5, wherein revoking comprises:
storing an indication of the revoked application-specific certificate in a certificate revocation list.

7. The method of claim 1, further comprising:
integrating the application with a registration authority for registering subscribers and revoking subscribers' certificates;
in response to a subscriber being registered, issuing an application-specific certificate to the subscriber; and
in response to a subscriber's certificate being revoked, revoking the application-specific certificate of the subscriber.

8. The method of claim 1, wherein the master certificate and the application-specific certificate are each associated with a separate public key and a separate private key, and wherein issuing comprises:
encrypting the private key associated with the application-specific certificate using the public key associated with the master certificate.

9. The method of claim 8, further comprising:
in response to the subscriber successfully authenticating with an authentication service using the master certificate:
decrypting the private key associated with the application-specific certificate using the private key associated with the master certificate; and
authenticating the subscriber for the application using the decrypted private key associated with the application-specific certificate.

10. A method in a computer system for PKI-enabling a plurality of applications, the method comprising:
integrating a first application with a first certification authority for issuing certificates specific to the first application;
integrating a second application with a second certification authority for issuing certificates specific to the second application;
receiving notice of a registration authority registering a subscriber;
issuing a first application-specific certificate to the subscriber using the first certification authority, the first application-specific certificate for use by the first application; and
issuing a second application-specific certificate to the subscriber using the second certification authority, the second application-specific certificate for use by the second application.

11. The method of claim 10, further comprising:
integrating the first application with a first directory service for providing access to application-specific certificates for the first application.

12. The method of claim 11, wherein the first directory service comprises a certificate repository, and wherein issuing a first application-specific certificate comprises:
storing the first application-specific certificate in the certificate repository of the first directory service.

13. The method of claim 10, further comprising:
receiving notice of the registration authority revoking a certificate of the subscriber;
revoking the first application-specific certificate of the subscriber using the first certification authority; and
revoking the second application-specific certificate of the subscriber using the second certification authority.

14. The method of claim 13, wherein revoking the first application-specific certificate comprises:
storing an indication of the revoked application-specific certificate in a certificate revocation list.

15. The method of claim 10, further comprising:
integrating the first application with an application-specific registration authority for registering subscribers; and
in response to a subscriber being registered by the application-specific registration authority, issuing an application-specific certificate to the subscriber using the first certification authority.

16. The method of claim 11, further comprising:
integrating the second application with a second directory service for providing access to application-specific certificates for the second application.

17. The method of claim 16, wherein the second directory service comprises a certificate repository, and wherein issuing the second application-specific certificate comprises:
storing the second application-specific certificate in the certificate repository of the second directory service.

18. The method of claim 10, further comprising:
integrating the second application with an application-specific registration authority for registering subscribers; and
in response to a subscriber being registered by the application-specific registration authority, issuing an application-specific certificate to the subscriber using the second certification authority.

19. A method in a computer system for PKI-enabling a plurality of applications, the method comprising:
integrating each of a plurality of applications with an application-specific certification authority, the application-specific certification authority for issuing application-specific certificates;
receiving notice of a registration authority registering subscribers; and
issuing a corresponding application-specific certificate to each subscriber registered by the registration authority.

20. The method of claim 19, further comprising:
receiving notice of the registration authority revoking certificates of one or more subscribers; and
revoking the application-specific certificate of each subscriber for which a corresponding certificate was revoked by the registration authority.

21. A system for PKI-enabling an application, the system comprising:
an application-specific certification authority integrated with the application, the application-specific certification authority configured to issue an application-specific certificate to a subscriber in response to receiving notice of a master certification authority issuing a master certificate to the subscriber, the application-specific certificate for authenticating the subscriber for the application; and
a directory service integrated with the application and configured to provide access to application-specific certificates for the application.

22. The system of claim 21, wherein the directory service comprises one of a lightweight directory access protocol (LDAP) service, an X.500 directory, and a database.

23. The system of claim 21, wherein the directory service comprises a certificate repository for storing certificates specific to the application.

24. The system of claim 21, wherein the application-specific certification authority is further configured to revoke the subscriber's application-specific certificate in response to receiving notice of the master certification authority revoking the master certificate of the subscriber.

25. The system of claim 24, wherein the directory service comp rises a certificate revocation list for storing an indication of the revoked application-specific certificate.

26. The system of claim 21, further comprising:
an application-specific registration authority integrated with the application for registering subscribers and, in response to a subscriber being registered, instructing the first certification authority to issue an application-specific certificate to the subscriber, and, in response to a subscriber's certificate being revoked, instructing the first certification authority to revoke the application-specific certificate of the subscriber.

27. The system of claim 21, wherein the master certificate and application-specific certificate are each associated with a separate public key and a separate private key, the system further comprising:
an encryption module configured to encrypt the private key associated with the application-specific certificate using the public key associated with the master certificate.

28. The system of claim 27, further comprising:
a decryption module configured to decrypt the private key associated with the application-specific certificate using the private key associated with the master certificate in response to a subscriber successfully authenticating with an authentication service of the master certification authority using the master certificate and corresponding private key; and
an authentication module configured to authenticate a subscriber for the application using the decrypted private key associated with the application-specific certificate.

29. A system for PKI-enabling a plurality of applications, the system comprising:
a first certification authority integrated with a first application, the first certification authority for issuing a first application-specific certificate to a subscriber in response to receiving notice of a registration authority registering the subscriber, the first application-specific certificate for use by the first application; and
a second certification authority integrated with a second application, the second certification authority for issuing a second application-specific certificate to a subscriber in response to receiving notice of the registration authority registering the subscriber, the second application-specific certificate for use by the second application.

30. The system of claim 29, further comprising:
a first directory service integrated with the first application for providing access to application-specific certificates for the first application.

31. The system of claim 30, wherein the first directory service comprises a certificate repository for storing certificates specific to the first application.

32. The system of claim 29, wherein the first certification authority is further configured to revoke the first application-specific certificate of the subscriber in response to receiving notice of the registration authority revoking a certificate of the subscriber.

33. The system of claim 32, further comprising:
a first directory service integrated with the first application for providing access to application-specific certificates for the first application, wherein the first directory service comprises a certificate revocation list for storing an indication of the revoked application-specific certificate.

34. The system of claim 29, further comprising:
an application-specific registration authority integrated with the first application for registering a subscriber and, in response to the subscriber being registered, instructing the first certification authority to issue an application-specific certificate to the subscriber.

35. The system of claim 30, further comprising:
a second directory service integrated with the second application for providing access to application-specific certificates for the second application.

36. The system of claim 29, wherein the second certification authority is further configured to revoke the second application-specific certificate of the subscriber in response receiving notice of the registration authority revoking a certificate of the subscriber.

37. The system of claim 36, further comprising:
a second directory service integrated with the second application for providing access to application-specific certificates for the second application, wherein the second directory service comprises a certificate revocation list for storing an indication of the revoked application-specific certificate.

38. The system of claim 29, further comprising:
an application-specific registration authority integrated with the second application for registering subscribers and, in response to a subscriber being registered, instructing the second certification authority to issue an application-specific certificate to the subscriber.

39. A system for PKI-enabling a plurality of applications, the system comprising:
an application-specific certification authority integrated with each application, the application-specific certification authority for issuing application-specific certificates;
a registration monitoring component integrated with each application-specific certification authority, the registration monitoring component for receiving notice from a registration authority of registration of subscribers; and
a certificate issuance component integrated with each application-specific certification authority, the certificate issuance component for issuing an application-specific certificate to each subscriber registered by the registration authority.

40. The system of claim 39, further comprising:
a revocation monitoring component integrated with each application-specific certification authority, the revocation monitoring component for receiving notice from a registration authority of revocation of subscribers' certificates; and
a certificate revocation component integrated with each application-specific certification authority, the certificate revocation component for revoking the application-specific certificate of each subscriber for which a certificate is revoked by the registration authority.

41. A computer program product for PKI-enabling an application, the computer program product comprising:
program code for integrating the application with an application-specific certification authority for issuing application-specific certificates;
program code for receiving notice of a master certification authority issuing a master certificate to a subscriber; and
program code for issuing to the subscriber an application-specific certificate corresponding to the master certificate, the application-specific certificate for use by the application.

42. The computer program product of claim 41, further comprising:
program code for integrating the application with a directory service for providing access to application-specific certificates for the application.

43. The computer program product of claim 42, wherein the directory service comprises one of a lightweight directory access protocol (LDAP) service, an X.500 directory, and a database.

44. The computer program product of claim 42, wherein the directory service comprises a certificate repository, and wherein issuing comprises:
program code for storing the application-specific certificate in the certificate repository of the directory service.

45. The computer program product of claim 41, further comprising:
program code for receiving notice of the master certification authority revoking the master certificate of the subscriber; and
program code for revoking the application-specific certificate of the subscriber corresponding to the revoked master certificate.

46. The computer program product of claim 45, wherein revoking comprises:
program code for storing an indication of the revoked application-specific certificate in a certificate revocation list.

47. The computer program product of claim 41, further comprising:
program code integrating the application with a registration authority for registering subscribers and revoking subscribers' certificates;
program code for, in response to a subscriber being registered, issuing an application-specific certificate to the subscriber; and
program code for, in response to a subscriber's certificate being revoked, revoking the application-specific certificate of the subscriber.

48. The computer program product of claim 41, wherein the master certificate and the application-specific certificate are each associated with a separate public key and a separate private key, and wherein issuing comprises:
program code for encrypting the private key associated with the application-specific certificate using the public key associated with the master certificate.

49. The computer program product of claim 48, further comprising:
program code for, in response to the subscriber successfully authenticating with an authentication service using the master certificate:
program code for decrypting the private key associated with the application-specific certificate using the private key associated with the master certificate; and
program code for authenticating the subscriber for the application using the decrypted private key associated with the application-specific certificate.

50. A computer program product for PKI-enabling a plurality of applications, the computer program product comprising:
program code for integrating a first application with a first certification authority for issuing certificates specific to the first application;
program code for integrating a second application with a second certification authority for issuing certificates specific to the second application;
program code for receiving notice of a registration authority registering a subscriber;
program code for issuing a first application-specific certificate to the subscriber using the first certification authority, the first application-specific certificate for use by the first application; and
program code for issuing a second application-specific certificate to the subscriber using the second certification authority, the second application-specific certificate for use by the second application.

51. The computer program product of claim 50, further comprising:
program code for integrating the first application with a first directory service for providing access to application-specific certificates for the first application.

52. The computer program product of claim 51, wherein the first directory service comprises a certificate repository, and wherein issuing a first application-specific certificate comprises:
program code for storing the first application-specific certificate in the certificate repository of the first directory service.

53. The computer program product of claim 50, further comprising:
program code for receiving notice of the registration authority revoking a certificate of the subscriber;
program code for revoking the first application-specific certificate of the subscriber using the first certification authority; and
program code for revoking the second application-specific certificate of the subscriber using the second certification authority.

54. The computer program product of claim 53, wherein revoking the first application-specific certificate comprises:
program code for storing an indication of the revoked application-specific certificate in a certificate revocation list.

55. The computer program product of claim 50, further comprising:
program code for integrating the first application with an application-specific registration authority for registering subscribers; and
program code for, in response to a subscriber being registered by the application-specific registration authority, issuing an application-specific certificate to the subscriber using the first certification authority.

56. The computer program product of claim 51, further comprising:
program code for integrating the second application with a second directory service for providing access to application-specific certificates for the second application.

57. The computer program product of claim 56, wherein the second directory service comprises a certificate repository, and wherein issuing the second application-specific certificate comprises:
program code for storing the second application-specific certificate in the certificate repository of the second directory service.

58. The computer program product of claim 50, further comprising:
program code for integrating the second application with an application-specific registration authority for registering subscribers; and
program code for, in response to a subscriber being registered by the application-specific registration authority, issuing an application-specific certificate to the subscriber using the second certification authority. program code for, in response to a subscriber's certificate being revoked, revoking the application-specific certificate of the subscriber using the second certification authority.

59. A computer program product in a computer system for PKI-enabling a plurality of applications, the computer program product comprising:
program code for integrating each of a plurality of applications with an application-specific certification authority, the application-specific certification authority for issuing application-specific certificates;
program code for receiving notice of a registration authority registering subscribers; and
program code for issuing a corresponding application-specific certificate to each subscriber registered by the registration authority.

60. The computer program product of claim 59, further comprising:
program code for receiving notice of the registration authority revoking certificates of one or more subscribers; and
program code for revoking the application-specific certificate of each subscriber for which a corresponding certificate was revoked by the registration authority.
